(19) United States
(12) Patent Application Publication
(10) Pub. No.: US 2021/0277620 A1
(43) Pub. Date: Sep. 9, 2021

(54) GOLF COURSE BUNKER

(71) Applicant: ECOBUNKER LIMITED, Cardiff, Wales (GB)

(72) Inventor: Richard Alec ALLEN, Cardiff, Wales (GB)

(21) Appl. No.: 16/321,626

(22) PCT Filed: Jul. 28, 2017
(86) PCT No.: PCT/GB17/52214

§ 371 Date: Jan. 29, 2019

Related U.S. Application Data
(60) Provisional application No. 62/368,692, filed on Jul. 29, 2016.

(51) Int. Cl. E02D 29/02; A63B 69/36; E02D 17/20; A01G 20/00

(52) U.S. Cl. CPC E02D 29/025; A63B 69/3691; A01G 20/00; E02D 29/0266; E02D 17/205

(57) ABSTRACT

The present invention concerns a method of constructing a golf course bunker (100) using concrete modified soil (“CMS”) as a backfill material (203) to secure the bunker facade tiles (201, 202) into place.

### BACKGROUND OF THE INVENTION

The present invention concerns a golf course bunker and a method of constructing a golf course bunker using concrete modified soil (“CMS”) as a backfill material to secure the bunker facade tiles into place.

The maintenance of a golf course is crucial to the golfer and as such to the success of a golf course in general. The level of maintenance is directly related to many issues, but it is the quality of the playing surfaces and the appearance of the golf course that matter most to the average golfer. One of the most demanding areas in terms of the expense, time, effort and labor is the maintenance of golf course bunkers. Golf bunkers are critical to the strategy and appearance of most golf courses and this has been the case for hundreds of years. Despite this long time span, and the many efforts that have been made, no satisfactory solution has been developed that can substantially reduce the maintenance burden, whilst at the same time ensuring that bunker quality is retained.

Green keepers will bear witness to the challenging tasks of maintaining bunkers and the majority of them will pinpoint bunkers as their most time intensive and problematic areas.

Likewise those who finance a golf course will testify to the disproportionate expense involved in maintaining bunkers. This is necessary due to a combination of factors: heavy rain which washes elements of the face away, erosion of the face, subsidence, damage to the face caused by golf clubs as well as golf balls, damage caused by animals, and wear and tear caused by machinery in or around the bunker. There are many different types of bunkers, but the problems described above are common to all bunkers. Steep faced, or revetted face bunkers which are often critical components in the character of many golf courses (common on links land golf courses in the UK, for example) are particularly susceptible to undermining and collapse.

Many golf course owners spend large sums of money on renewing revetted faces on bunkers. Revetted face bunkers need rebuilding on average every 3 years. Slopes that face adverse prevailing weather conditions can often become unstable much sooner than that. In an attempt to stabilize bunker faces some Championship courses have installed custom designed water sprinkler systems to all their revetted bunkers. This is only possible via the large amounts of grant aid and sponsor money made available to support major professional tournaments. This sort of solution is impossible on financial grounds for the vast majority of golf courses. Furthermore, the large volume of irrigation water required raises the issue of sustainability and it is highly questionable whether this sort of practice should be permitted by agencies with environmental responsibility.

Maintenance of bunkers has received much attention and much prior art exists relating to the maintenance of bunker borders and prevention of sand migration or weed creep. However, very little of this prior art appears to have become widespread in the golfing world, and the problem of bunker face and edge maintenance remains an unsolved issue. Recent solutions have included seemingly dangerous and/or ineffective use of timber facings, formed in some cases simply by arranging vertically extending lengths of timber against the inner wall or face of the bunker. In some cases, old railway sleepers have been used to define a retaining wall.

It is believed that golf courses favor non-synthetic (or “natural”) construction materials for facing bunkers so as to fit in and match the aesthetic look and feel of the rest of the golf-course.

The Alice Springs golf club, near Usk, Wales, has bunkers which include a single layer of artificial grass that extends from a top surface of the bunker, over and partway down the sloping face of the bunker. GB 2398508 discloses a practice golf bunker in the form of a free standing and static sand tray. The tray is higher at one end and curved to form the bunker wall which is covered with a single non-horizontal layer of artificial turf.

Prior art describes other methods of making and securing layers of artificial turf together, such as in U.S. Pat. No. 4,138,514 to Terpay, which describes using polymeric tape and horizontally positioned pins to hold together layers of artificial turf. U.S. Patent Application Pub. No. 2016/0040367 to Allen, incorporated herein by reference in its entirety, also describes a method of processing artificial turf, to make strips of artificial turf for use in a walled structure such as a golf bunker.

Prior art also describes methods of building a retainer wall, and retaining wall structures. For example, US Patent Application Pub. No. 2010/0092251 to Heselden describes the use of a spiral coil to connect tiles together to build a defense wall. U.S. Patent Application Pub. No. 2015/0063924 to Brookhart et al. describes a system and method for a retaining wall that relies on tieback members that are horizontally positioned from the back side of the facade surface into the backfill, to hold the members of the retaining wall in place.

U.S. Design Patent D682,966 to Allen et al. describes an ornamental design for a golf course bunker, which discloses an example of the artificial turf-covered surface of a tile for a golf bunker in the present invention. U.S. Patent Application Pub. No. 2013/0116060 to Allen, now abandoned, discloses a golf course bunker with pieces of artificial turf positioned and held in place with ties to create a golf bunker. The present invention is an improvement upon such a golf course bunker.

### SUMMARY OF THE INVENTION

A golf course bunker includes a sloped surface defined at least partly by a plurality of layers of artificial grass, the plurality of layers being substantially horizontal and arranged in a staggered arrangement corresponding to the gradient of said sloped surface.

A method of constructing a golf course bunker at a golf course includes forming an excavation having an exterior surface, creating tiles with an exterior surface that is artificial grass arranging the layers of artificial grass in a plurality of horizontal layers in a staggered arrangement to face the exterior surface of the excavation, adding CMS to backfill the volume between the excavated surface and the stacked tiles, and securing the tiles to the CMS backfill.

The present invention is an improvement over the prior art because it relies on fewer structural components than existing retaining wall structures, is easier to assemble than existing golf bunkers, lasts for a longer period of time than previous artificial turf golf bunkers, and requires less maintenance than natural turf bunkers.

Previous bunker walls may not be as durable where the slope of the wall is 45 degrees or less because the weight of the wall causes tiles to slip out into the bunker. The present invention, however, with the use of CMS to help the tiles remain in place, allows for greater durability and load bearing capabilities regardless of the angle of the wall.

### BRIEF DESCRIPTION OF THE DRAWINGS

Embodiments of the present invention will now be described by way of example only with reference to the accompanying schematic drawings of which:

FIG. 1 shows a sectional view of a golf bunker according to a first embodiment of the invention.

FIG. 2 is an enlarged sectional view showing the tiles keyed in to the CMS of FIG. 1 in greater detail.

FIG. 3 is a flow chart of the method of making a bunker according to the present invention.

### DETAILED DESCRIPTION

The present invention provides a golf course bunker comprising a plurality of layers of tiles with an artificial grass surface facing an exterior surface of a bunker. The use of artificial grass in layers in embodiments of the present invention advantageously enables the provision of a durable and low maintenance facing for the bunker which also has an appearance that complements the look and feel of a typical golf course.

In the context of the present invention, a bunker may be in the form of a depression in the course, typically filled at least partially with sand or other granular material, and/or grass. The bunker need not be bounded on all sides by sloped surfaces that extend upwardly in a direction away from the bunker. It will be appreciated that the plurality of layers of artificial grass define a facing of at least part of such a sloped surface. The present invention has particular advantage in relation to bunkers having at least one steeply sloped surface, but is not limited in application only to such steep bunkers. A surface may (optionally) be considered as “steep” if it has a gradient steeper than 1:3 over a distance of more than 500 mm. A surface of the bunker may have an average gradient of steeper than 1:1 over a distance of more than 500 mm.

The present invention has particular advantage in relation to bunkers having at least one revetted surface (i.e. a wall that forms or defines a revetment). The revetment may be made of layers of tiles of varying depths, having external facing surfaces covered with artificial grass. The revetted surface may have a gradient of steeper than 1:1 over a distance of more than 500 mm. The revetted surface may be in the form of a retaining wall. The revetted surface preferably has an upper edge, from which a layer of turf, whether artificial or natural, extends away from the bunker. Thus, in this case, the bunker has an upper surface having a layer of turf that terminates at this edge, and does not roll over the edge and down into the bunker.

The layers of tiles may be separated by other layers of material. It is preferred however for the layers of artificial grass to be arranged one on top of the other, preferably in direct contact with each other. The plurality of layers tiles of artificial grass are preferably arranged in a substantially horizontal orientation. When constructing the bunker, having successive layers of tiles arranged substantially horizontally, may improve structural stability of the stack of tiles. It will be understood that the layers need not be exactly horizontal. The layers of artificial grass tiles may be staggered. Thus, for example, one layer of tiles may have an upper surface that is only partially covered by the layer on top, thus leaving part of the upper surface exposed. The layers may thus have a stepped appearance. The layers may have a varying stagger. The gradient of the wall/surface of the bunker defined by the layers may vary.

Each tile may comprise a layer of artificial grass made of synthetic grass fibers attached to a backing material. The synthetic grass fibers may be made from or comprise polypropylene. The backing material may be a rubber or plastic material, such as for example latex. The backing material may be secured to the artificial turf through an epoxy, glue, or other attachment means. In an alternative embodiment, the tiles may be prefabricated, and cut from recycled or previously used artificial turf. The backing material may support a granular material that fills at least some of the space between the synthetic grass fibers. Such a granular material, preferably sand, may increase the density of the layers. Providing such a granular material may assist in distributing load. It may for example reduce the amount by which layers of artificial grass in a vertically low (relatively high-load) region of the bunker are compressed compared to layers in a vertically high (relatively low-load) region of the bunker. The depth of the pile (the height of the grass fibers above the backing material) is preferably greater than 10 mm. The depth of the pile is preferably less than 35 mm and may be less than 25 mm. The depth of the pile may be greater than 15 mm.

There may be many separate pieces of tiles in each layer. Each piece may have a width of between 100 mm and 500 mm, and preferably a width of between 100 mm and 200 mm. Each piece may have a length of between 100 mm and 1000 mm. Each piece is preferably arranged such that its length extends left-to-right (or right-to-left) across the exterior face of the bunker and such that its width extends into the bunker. The tiles may be stacked in horizontal rows, where each row extends across the length of the bunker. The tiles in each row may be of varying lengths in the same row.

The artificial grass attached to the tiles are preferably formed from pieces of artificial grass turf that have been previously used as artificial grass for a different application. Using such “second hand” (or “used”) artificial grass has the advantage of reducing cost, but also has the advantage of providing a viable second/further use of artificial grass turf that has been used in a conventional application (such as on a football pitch for example). Artificial grass surfaces, as used in such conventional applications, typically have a useable lifetime of several years, but will need nevertheless to be replaced from time to time. When replaced, it is common practice simply to dispose of used artificial grass as refuse in land-fill sites. The present invention provides a means of re-using/re-cycling used artificial grass. It will be appreciated that the quality of the artificial grass required for the present invention is lower than that required for, for example, a football pitch and that therefore the present invention provides an advantageous means of extending the useful life of such artificial grass.

The tiles with an artificial grass-covered exterior surface advantageously define an exterior surface of the bunker. The interior of the bunker is preferably formed of CMS.

The CMS is a mixture of existing compositions. The CMS consists of a mixture of cement and soil and water. The soil may be that of the excavated earth to create the bunker, or it may be soil taken from an off-site location. For example, if the earth excavated to create the bunker is very crumbly, it will be a good soil to mix with the cement powder. However, if it is more clay-like in composition, it will be heavy and retain more water, thus making it preferable to use a foreign soil. The soil used and the exact cement to soil ratio will vary on a site-by-site basis, as each bunker will be excavated from a different earth soil composition. The soil mixed with the cement powder may be local soil, foreign soil, or a mixture of foreign and local soil. The soil may be mixed with a small proportion of cement powder to create a weak cement. The advantage of mixing a weak cement is that it may be made in larger batches because it takes longer to set. Thus, care can be taken when building a retaining wall of artificial turf tiles and CMS, because there is ample time to gradually fill the space behind the wall as the wall is built.

The bunker may be considered as comprising an exterior facing wall and infill material, the infill material filling in the interior of the bunker. Such infill material may be CMS as described above. The use of CMS for infill material may help hold the tiles in place for a longer duration without requiring the use of additional tie pins. One or more of the tiles may extend further, width-wise, into the interior of the bunker than the rest of the tiles so as to key-in to the different material. An entire row of horizontally positioned tiles may extend farther into the interior of the space behind the revetment wall than the rows immediately above and below it. Or, just individual tiles in that horizontal row may extend further width-wise into the bunker, with the tiles immediately to the left and right of it not extending as far into the interior of the bunker.

In another embodiment, the layers of artificial grass may be tied together. For example, one or more elongate tie members may pass through each layer of a plurality of stacked layers of artificial grass. The one or more elongate tie members may be substantially rigid, for example in the form of a screw, pin, post, bolt, or the like. The present invention is advantageous in that tie members only need to pass through the top-most layers of tile. In fact, in the present invention, tie members are not necessary to achieve the objective of a more sturdy retaining wall. But if desired, the ties may pass through the first two, or three, or four layers of tile. This is advantageous because less or zero ties need to be used, as compared with previous bunker walls, which required tie members every few rows of horizontally stacked tiles. The layers of artificial grass may be anchored together by means of an anchor member.

The present invention also provides a method of constructing a golf course bunker. The golf course bunker so constructed may be in accordance with the golf course bunker as described or claimed herein. The method preferably comprises the steps of (a) forming an excavation having an exterior surface; (b) mixing the CMS from cement powder and soil; (c) forming the tiles of artificial grass or obtaining pre-formed turf tiles; and (d) laying the tiles in horizontal layers, preferably staggered layers, to create the required shape, height and gradient to face the exterior surface of the excavation; and (e) backfilling in the excavated earth behind the tile layers. The CMS may be added to backfill the excavated earth after laying of a few tile layers, then more tiles can be laid followed by more CMS, etc.

The method may include a step of cutting layers of artificial grass, for example, to cut the layers to size. The excavation is preferably formed in situ at the golf course for which the bunker is being constructed. The step of cutting the layers of artificial grass is preferably by means of mechanized machinery (i.e. more than a simple knife that would be used by hand). The mechanized machinery may be manually operable. The mechanized machinery will typically need to be located at a site other than the golf-course. The step of cutting the layers of artificial grass before laying them is preferably conducted at a site remote from the excavation, and preferably not on the golf course. Using mechanized machinery has been found to give a better finish and to be more reliable.

The method may include a step of cutting at least one layer of artificial grass to form an incision. The incision may provide sufficient flexibility to allow the layer of artificial grass to be manipulated to suit the contours of the exterior surface of the excavation, whilst maintaining the appearance of the front facing surface of the bunker. Preferably, the incision is hidden from view in the final completed bunker. The incision may be formed in the rear surface of the layer of artificial grass. The incision may allow the layer of artificial grass to be more readily stretched along its rear surface. The incision may facilitate removal of a portion, for example a wedge-shaped portion, of the layer of artificial grass to be removed, thus allowing the layer to be more readily compressed along its rear surface.

The exterior-facing surface of the tiles, with layers of artificial grass, are preferably impregnated with sand before being laid. The artificial grass may be at least partially impregnated with sand before the step of cutting the layers of artificial grass. Mechanized cutting is preferable here, as more sand is retained than when cutting manually.

The step of laying the tiles in horizontal layers may include adding regulating material in between successive layers. There may be a step of laying a first layer, and then adding regulating material directly on top of the first layer to create an even and level surface on which to lay a second layer. There may then be a step of laying a second layer on top of the regulating material on the first layer. The regulating material may comprise granular material. The regulating material may comprise sand. The regulating material may comprise soil.

The method may include filling in the volume defined by the remaining natural earth behind the wall and the revetment wall built from artificial turf tiles. The CMS may be added as the wall height is increased, so that the wall height and the CMS height increase proportionally relative to each other. For example, the width of the CMS may extend approximately one foot behind the turf tiles. The volume of the CMS will vary based on the required height of the bunker wall, the natural earth materials behind the wall, and the imposed load on the ground behind the wall. For example, a bunker built close to a golf cart path will be subject to a different force load than a bunker wall built next to a maintenance vehicle road. The shape of the CMS volume will be determined on site as a field assessment.

The wall made of turf tiles may be one of a wide variety of shapes, and will vary depending on a field assessment made of the surrounding environment.

The CMS is in direct contact with the natural soil of the environment on its back and side surfaces that are not in contact with the turf tiles. The top surface will also be covered with natural soil.

Each of the longer tiles helps the wall key in to the CMS, and increases the strength of the wall.

The wall built with artificial turf tiles and CMS creates a heavier larger block, and increases the total weight holding the turf tile wall in place. The CMS behaves structurally as though it is a part of the wall. Without this improvement of using CMS however, the only weight of the wall is that of the tiles itself, because they would be keyed into a natural soil. The wall built according to the present invention is a gravity retaining structure where its self weight is the primary resisting force.

The method may include a step of adding natural turf to the top of the CMS and tiles, to make the height flush with the surrounding environment which may be natural turf. The method may include a step of adding topsoil to the bunker. The method may include a step of adding seed to the topsoil. Topsoil is preferably added on the uppermost surface of the CMS and tiles. Preferably, the topsoil has a depth of greater 30 mm, and may be greater than 40 mm. A natural turf layer is preferably laid on the topsoil. In the case where the artificial grass layers hold sand, it is desirable to have some moisture retained within the layers to aid retention of the sand within the layers. Adding natural soil and turf on the top of the bunker can aid such moisture retention. There may be 6-12 inches of topsoil; preferably 6 inches of natural soil, placed on top of the bunker, to provide a deep enough soilbed for natural turf to grow and remain in place. Natural turf is a protective layer with a root structure protects the bunker from rainfall which could erode the CMS.

The present invention may have application in relation to structures other than golf course bunkers. For example the tiles could be used as a facing on a retaining wall. Thus, in accordance with a broader aspect of the invention there is provided a structure, for example a facing, comprising a plurality of layers of tiles with artificial grass-covered exterior surfaces, layered one on top of the other. The structure may have one or more of the features of the golf bunker as described above or claimed herein. In accordance with this broadened aspect of the invention, there is provided a method of constructing a structure comprising a plurality of layers of tiles, with artificial grass-covered exterior surfaces.

It will of course be appreciated that features described in relation to one aspect of the present invention may be incorporated into other aspects of the present invention. For example, the method of the invention may incorporate any of the features described with reference to the bunker/structure of the invention and vice versa.

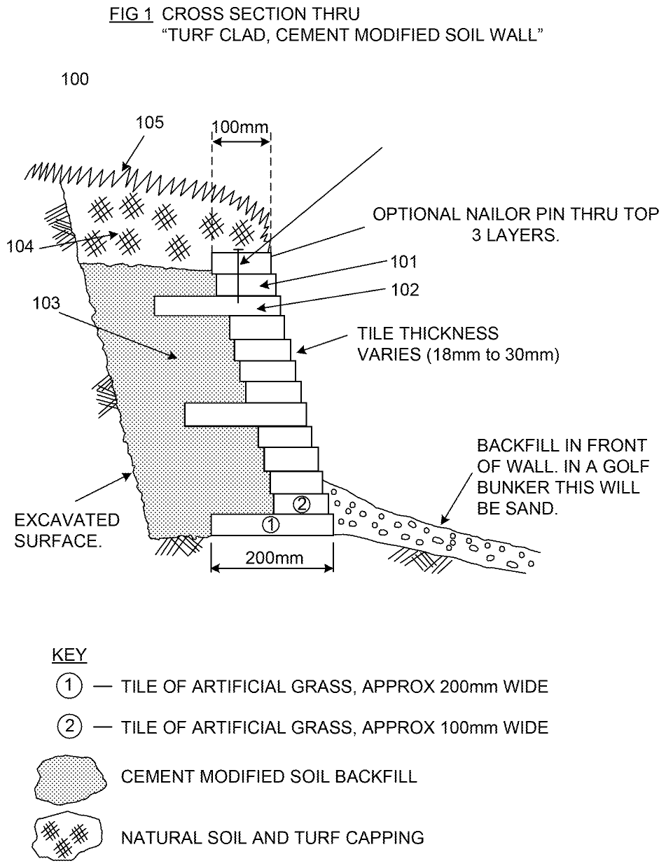

A first embodiment of the invention is shown in FIG. 1, which illustrates in cross-section a bunker 100 on a golf course, the bunker 100 comprising a plurality of layers of tiles 101 and 102. The tiles have a surface covered with artificial grass. The use of these tiles, placed in horizontal layers at a varying stagger creates a durable, low maintenance, bunker, in particular the slopes and edges of the bunker 100. The volume behind the back surface of the tiles 101 and 102 is filled with CMS 103. The top of the bunker wall and top of CMS is covered with a soil layer 104. The soil layer 104 is covered with a layer of natural turf 105.

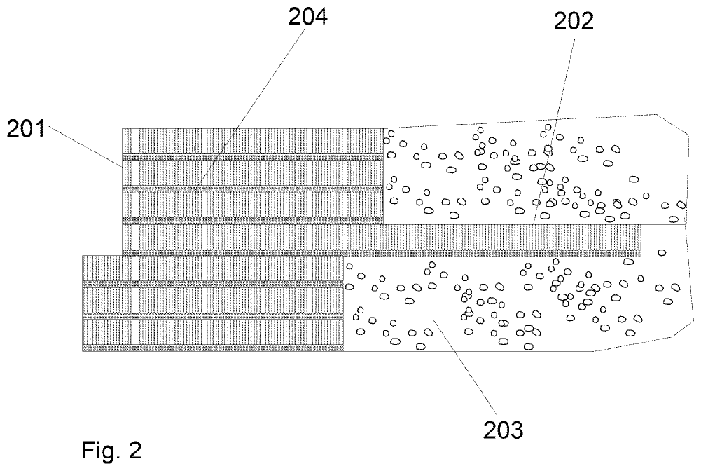

FIG. 2 shows a close-up/enlarged view of the tiles keyed in to the CMS of FIG. 1. It will be seen from FIG. 2 that the for every four shorter tile 201 layers, there is a layer of a greater width tile 202. FIG. 2 shows how the tiles are embedded in the CMS, and that the greater width tiles 202 extend more into the CMS 203 than the shorter tiles 201. The shorter tiles may have a width of approximately 100 mm and the greater width tiles may have a width of approximately 200 mm.

Each tile 201 and 202 of artificial grass comprises a layer of artificial grass, a latex backing material 204, and a polypropylene pile material attached to the backing material. The depth of the pile is 20 mm. The artificial grass is sand filled. The tiles may be of varying lengths, where the length is defined as the distance between the left edge of the front artificial grass-covered surface of a tile and the right edge of the same surface of the tile. The tiles may each have a width of 100 mm, and some tiles may have a width of 200 mm, where the width is defined as the distance between the front artificial-grass covered surface of the tile and the back end of the tile, which is a vertical surface in contact with the backfill material. The tiles are arranged in horizontal rows, each row stacked upon another row. The rows of tiles are arranged such that the rows have varying widths of tiles from each other. There may be two, three, four, or five rows of tiles with a shorter width, followed by one row of tiles with a greater width. The tiles with the shorter width may have a width of 50 mm to 150 mm. The tiles with a greater width may have a width of 200 mm to 400 mm. The interior of the bunker is formed from CMS. The top two, three, four, or five layers of tile may be tied together by means of anchor pins. The size of the tiles enables the bunker construction to need anchor pins through only the top two or three or four layers. The tiles may have a thickness, which is the distance from the lower surface of the tile to the top surface of the tile once it is in place in the bunker wall, of between 18 mm to 30 mm.

The materials required, the mode of construction and the ongoing maintenance are described as follows, all in relation to the first embodiment.

Artificial grass is provided. Artificial grass generally consists of synthetic grass fibers (nylon or polypropylene), a backing material (a range of products including polyurethane, canvas or latex) and an infill (typically sand). New artificial grass can be purchased from a wide range of suppliers, however the first embodiment of the present invention is best suited to the use of second hand (“used”) artificial grass. Used artificial grass is also widely available as it has a finite lifespan in its primary use as a football pitch, tennis court, field hockey pitch, etc. At present a high proportion of used artificial grass ends up in landfill sites. This secondary use for the artificial grass would provide a new market for the material and significantly reduce waste.

The construction of the bunker of the first embodiment is undertaken in three principal stages. Firstly the bunker faces and edges are excavated to the client's required dimensions. Secondly the artificial grass may be cut by a sharp knife to create the tiles and suit the dimensions of the excavation. The tiles may be cut on a site-by-site basis, as each individual golf bunker will naturally have somewhat different dimensions. When it is processed, care must be taken to retain the majority of the sand within the pile structure of the artificial grass. Third, the tiles are stacked on top of each other, and the CMS is added to the volume that was previously excavated. Once the full height of the bunker wall has been reached by stacking tiles on top of each other, and CMS is added to backfill the excavated volume to the proper height, natural turf is laid on top of the CMS.

In the case where the piece of artificial grass is to be used to face a sharply curving portion of the bunker (i.e. curving in the horizontal plane to an extent that cannot be accommodated by the inherent flexibility of the pieces of artificial grass being used), one or more small incisions are made on the back facing surface of each strip of artificial grass. The incisions provide a degree of flexibility which allows the artificial grass to be manipulated to suit the required contours of the bunker face, whilst maintaining the appearance of the front facing surface which is seen by the golfer. There may be one incision or two incisions made at the back facing surface.

Finally, the tiles with a surface of artificial grass are laid by hand in horizontal layers to create the required shape, height and gradient. Each layer is laid and then levelled and made solid by means of adding and tamping down extra soil/sand or CMS on top of the layer as required. A modest amount of natural turf, topsoil and seed is then used to marry the artificial structure into the natural contours, for example at a region at the top of the bunker. Under most ground conditions the self weight of the artificial turf (which is pre impregnated with sand) is sufficient to provide adequate slope stability. Sand may also be added (or already provided) to form the base of the bunker. Each layer is formed of many strips laid end-to-end. Typical (plan-view) dimensions of a strip are a width of between about 100 mm and about 300 mm and a length of about 500 mm.

Ongoing maintenance may also be required. However, the maintenance of the artificial grass faces is minimal compared with traditional solutions that are formed from growing grass sod. The artificial faces are not reliant on good natural growing conditions or regular watering to keep their integrity and are much more durable to everyday wear and tear. Maintenance will be limited to occasional brushing to remove excess sand build up.

Aesthetics are very important, and the horizontal layering is critical in delivering the desired appearance. A very natural and pleasing appearance can be achieved by means of embodiments of the present invention.

A revetted wall of a bunker which has been faced by means of a second embodiment of the invention may exist. Natural sand provided in the base of the bunker and turf is provided on the top of the revetted wall. The principal differences between this second embodiment and the first embodiment will now be described. The slope of the wall of the bunker defined by the tile layers is steeper. The staggering is less pronounced in view of the steepness of the wall.

Every third, fourth, fifth, or sixth layer is greater in the direction/dimension that extends into interior of the bunker, which facilitates a key-in between the wall and the excavation, thus providing better stability. Lastly the pieces of sand-filled artificial turf are cut to size with an angle-grinder with a suitable cutting disc attached.

Another embodiment of the bunker may exist, with a three-dimensional shape, illustrating in highly schematic form the type of three-dimensional shape of bunker made possible by means of the present invention. Thus the bunker includes a base that is substantially horizontal and filled with sand, which is surrounded by a steeply sloping retaining wall defined by multiple staggered layers of artificial turf. The bunker is formed as a depression in the surrounding land and thus the top region of the bunker is relatively flat, and is level with the surrounding land. In this embodiment, the top region is in the form of natural turf which terminates at the edge between the flat level land at the top region and the steeply sloping retaining wall. In the finished bunker, the multiple layers that form the side wall of the bunker are readily visible when close to the bunker, but are defined by materials such that from a distance the look and appearance of the bunker marries in well to its surroundings.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

While the method and invention of a synthetic bunker face has been described with certain degrees of particularity, the structure of each bunker face may change or be modified. A first constant feature is artificial grass laid as (preferably horizontal) layers, and this is a unique solution to the problem of economically maintaining aesthetically pleasing bunker faces and edges. A second constant feature is having some of the rows of tiles extend farther into the CMS to key the tile in to the CMS.

All the dimensions of the bunkers shown in the Figures can be amended on site to suit particular local ground conditions and client requirements.

A retaining wall as described above could be used as a landscaping tool in other contexts, not solely for golf course bunker landscaping.

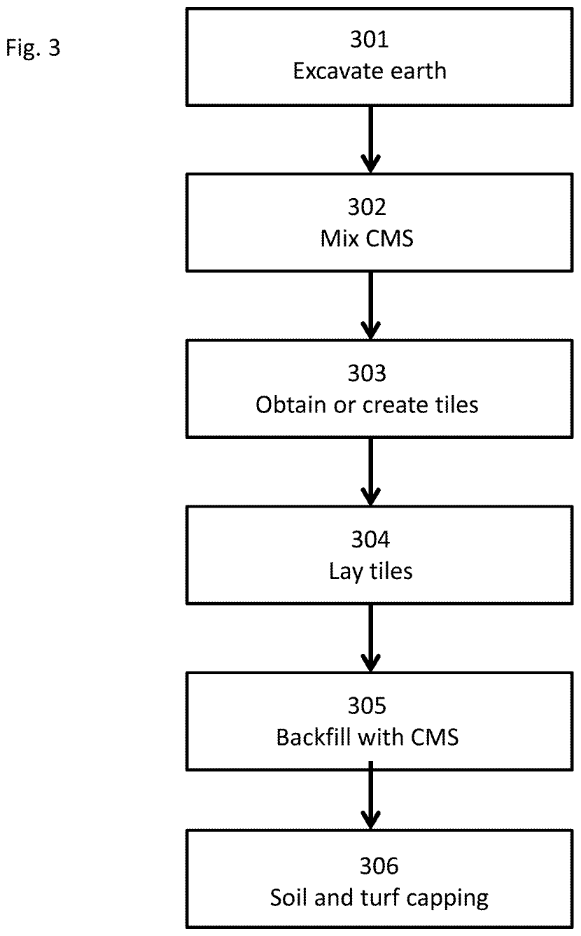

A method of making the bunker is outlined in FIG. 3. First, an excavation of the site where the bunker is to be constructed 301 must be made. Second, a CMS mixture must be made 302. The CMS may be made according to the criteria set forth in this application. Next, the tiles must be made to the proper size or obtained and brought to the site of the bunker 303. Then, the tiles should be laid in horizontal layers at the position where the revetment wall is desired to be placed 304. The tiles are preferably laid in staggered layers. Three or four or five or six layers of tile may be laid during this step. The next step 305 requires the CMS to be added to the excavated space between the wall of tile being built and the natural environment behind the wall. Steps 304 and 305 may be repeated as many times as necessary to achieve the desired height of the wall. In step 306, natural soil may be added on top of the CMS and top layer of turf tiles. In step 307, turf capping takes place by placing natural turf or seeds to grow natural turf on top of the natural soil layer. The specific details of the components and the dimensions may be as stated herein.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

While the embodiments have been particularly shown and described within the framework of the exemplary embodiments, it will be appreciated that variations and modifications may be effected by a person of ordinary skill in the art without departing from the scope of the invention. Furthermore, one of ordinary skill in the art will recognize that such processes and systems do not need to be restricted to the specific embodiments described herein. Other embodiments, combinations of the present embodiments, and uses and advantages of the present invention will be apparent to those skilled in the art from consideration of the specification and practice of the invention disclosed herein. The specification and examples should be considered exemplary.

What is claimed is:

1. A method of making a golf bunker, comprising the steps of:
excavating a hole into the ground;
obtaining tiles of a lesser width and tiles of a greater width, wherein the tiles comprise an artificial grass-covered surface;
layering tiles of a lesser width and placing one layer of tile of the greater width on top of the layers of lesser width;
backfilling a volume behind the tiles with cement modified soil;
repeating the steps of layering tiles and backfilling a volume with cement modified soil until a desired bunker wall height is achieved;
covering the top layer of tiles and the top of the cement modified soil with natural soil; and
covering the natural soil with natural turf.
